(19) United States
(12) Patent Application Publication
(10) Pub. No.: US 2007/0248171 A1
(43) Pub. Date: Oct. 25, 2007

(54) Method and Device for Reading Data Received in Protected Form Corresponding Security Message Router and Tool for Removing Protection

(75) Inventors: Pascal Nourry, Rennes (FR); Michael Picaud, Betton (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/659,856

(22) PCT Filed: Aug. 5, 2005
(86) PCT No.: PCT/FR05/02039

§ 371 Date: May 22, 2007

(30) Foreign Application Priority Data
Aug. 9, 2004 (FR) 0408758

(51) Int. Cl. H04N 11/04

(52) U.S. Cl. 375/240.25

(57) ABSTRACT

The inventive method for reading data received in the protected form consists in transmitting at least certain protected data to a protection removing tool. The protected data is retrieved from a buffer memory of a read stream of said data and is transmitted to the protection removing tool by a security message router. To transmit between said security message router and the protection removing tool, data is recorded in assigned transfer frames.

The present invention relates to a method and a device for reading data received in a protected form. It also relates to a tool for removing the protection from the data and an appropriate system for implementing such reading method.

The invention applies in particular to the reading of multimedia data, for example MPEG-type data.

Some multimedia data transmitted by cable or satellite is protected by encoding, masking and/or scrambling, to ensure that a user of this data is authorized to use it. Such is the case, in particular, with confidential data or data to which access is subject to payment. For this, a data reading terminal must be associated with a tool for removing the protection from the data, which removes the protection before the data is read.

The DVB standard (“Common Interface Specification for Conditional Access and other Digital Video Broadcasting Decoder Applications”) proposes an interface between the data reading terminal and the protection removal tool which comes under the data transport level. In this case, the data protection implemented is linked to one of the data transport protocol layers. Such a protection method is limited to data that is transmitted using this protocol. The tool for removing the protection from the data that is associated with the reading terminal is then specific to the transport protocol, and is not universal.

Moreover, the following extensions of the MPEG standard: MPEG-2 IPMPX (ISO/IEC 13818-1FDAM2, ISO/IEC FDIS 13818-11) and MPEG-4 IPMPX (ISO/IEC 14496-1FDAM3 and ISO/IEC FDIS 14496-13: 2003) propose a messaging system between the data reading terminal and the protection removal tool. This messaging system makes it possible to transmit to the reading terminal commands produced by the protection removal tool. These commands are placed in transfer frames between the protection removal tool and the reading terminal, that are received by an IPMP (Intellectual Property Management and Protection) message router incorporated in the reading terminal. Such commands are executed within the reading terminal and can relate to operations performed directly on multimedia data. The duly controlled operations can in particular be performed on data contained in a buffer memory of the terminal. In this way, it is possible to remove a data protection concerning the “data” level, and that is independent of the transport protocols used.

In such a protection removal mode, the operations performed on the data are triggered by the protection removal tool, in a way that is unsynchronized with the arrival of the data to be read in the reading terminal. Somehow, the protection removal tool works anarchically on the data within the reading terminal. The result of this is irregular delays in the data processing, which can affect the quality with which the data read is presented to a user. Difficulties also arise in managing interventions of multiple protection removal tools, when at least two different protections are cumulatively applied to the data.

One object of the present invention is, consequently, to propose a method of removing a protection from data intended to be read, which does not have the abovementioned drawbacks.

To this end, the invention proposes a method for reading data received in protected form, comprising the following steps, for at least one of the received protected data items:
a—storing the protected data item in an input buffer memory unit;
b—sending a signal to a security message router, indicating that a protected data item is present in the input buffer memory unit;
c—producing a first data transfer frame;
d—reading the protected data item in the input buffer memory unit;
e—entering the protected data item in the first frame; and
f—transmitting the first frame containing the protected data item to a tool for removing the protection from the data item.

Thus, the invention provides for a transfer of data, from the reading terminal to the protection removal tool, which uses a transport frame dedicated to each data item. Each frame which thus transports a protected data item constitutes a message exchanged between the reading terminal and the protection removal tool.

In the context of the invention, the term “received data item” is used to mean an application data item, that is, a data item extracted from the transport frames used to transmit the latter between a sending server and the reading terminal. Consequently, a protection affected by the invention is independent of the transport protocols used for the transmission between the sending server and the reading terminal. Those skilled in the art will understand that it is therefore a “data” level protection.

According to the invention, the steps c, d, e and f are controlled by the security message router in response to the signal indicating the presence of a protected data item in the input buffer memory unit. Thus, when a data item from which the protection is to be removed arrives at the input of the reading subsystem, the security message router triggers the sending of this data item to the protection removal tool. The removals of the protections from data items received in succession can therefore be coordinated with each other by the security message router, such that delays in reading these data items can be avoided.

The detection of the protected data present in the input buffer memory unit before activating the security message router makes it possible to avoid unnecessarily sending data to the security message router. Resources of a terminal in which the invention is implemented are therefore not mobilized unnecessarily. This can be particularly advantageous for a terminal of limited capacity. Situations in which data does not need to be transmitted by the security message router are, for example:
when a protection is used selectively for certain data, the unprotected data does not need to be sent to the protection removal tool;
when access or usage rights are defined independently for different data streams, the data of certain streams only can be protected so that there is no need to send the unprotected data streams to a protection removal tool;
when a data access or usage right has been refused, there is no point in activating the security message router; and
avoiding transmitting protected data to the security message router when the protection removal tool required is not available or is not connected to the security message router.

Furthermore, the use of a signal that indicates the presence of a protected data item in the input buffer memory unit makes it possible to direct data to specific protection removal tools for separate streams, when different protection removal tools are used.

Finally, this also makes it possible to use several protection removal tools in succession for the same data, for example when an encryption and a digital tattooing, or even two digital tattooings, are applied in cascade to data.

In the same way, the router can coordinate the reception of each data item after the protection thereof has been removed within the tool. For this, the method can further comprise the following steps:
g—producing a second data transfer frame;
h—entering the unprotected data item in the second frame;
i—transmitting the second frame containing the unprotected data item to the security message router; and
j—storing the unprotected data item in the input buffer memory unit.

These steps g to j are performed, in particular, when the protected data item is an audio or video data item and not an access control data item.

The operation to remove the protection from a data item is executed entirely within the tool dedicated to this purpose. Thus, the protection used can be independent of the reading terminal. This makes it possible to implement various protections simply by adapting the protection removal tool, without having constraints associated with the reading terminal.

The steps g to i are executed within the protection removal tool, and the step j is controlled by the security message router.

When several protections are used together for data, respective removal tools for the different protections can be associated with the reading terminal. In this case, for at least one of the received data items protected in this way, the security message router successively selects one of the protection removal tools based on an access control table. It then sends the data item to this selected tool in order for the protection corresponding to this tool to be removed from said data item. The method is then repeated for the same data item with the next protection removal tool indicated in said access control table. The security message router then has a master function relative to the protection removal tools that work as slaves.

The invention also relates to a data reading terminal and a protection removal tool that are adapted to implement a method as described previously.

Such a reading terminal comprises:
an input buffer memory unit designed to store received data items;
at least one transfer message input/output port;
a security message router connected on the one hand to the input buffer memory unit and on the other hand to the transfer message input/output port;
means for detecting a protected data item in the input buffer memory unit; and
means for sending a signal to the security message router, arranged to be activated when a protected data item is detected in the input buffer memory unit.

The security message router incorporates the following means, arranged to be activated in response to a signal indicating detection of a protected data item in the input buffer memory unit:
means for producing a first data transfer frame;
means for controlling a read of a protected data item in the input buffer memory assembly;
means for entering a protected data item that has been read in a said first frame; and
means for transmitting a first frame containing a protected data item that has been read via the input/output port.

The security message router can further comprise:
means for reading an unprotected data item contained in a second frame received on the input/output port; and
means for controlling an entry, in the input buffer memory unit, of an unprotected data item that has been read in a said second frame.

To coordinate the removals of several protections applied to the data, the reading terminal can comprise several data transfer message input/output ports, means for storing an access control table, and means for selecting one of said input/output ports from said access control table, said selection means being arranged to be activated upon a transmission of a said first frame containing a protected data item.

A tool for removing a protection applied to data, that is adapted to implement the invention, comprises:
an input/output port for frames containing data;
means of reading a protected data item in a first frame received on the input/output port;
means of removing the protection from a data item that has been read;
means of producing a second data transfer frame;
means of entering in a said second frame a data item from which the protection has been removed; and
means of transmitting a second frame containing an unprotected data item via the input/output port.

The invention also relates to a system for reading data comprising a data reading terminal and at least one data protection removal tool as described previously, the tool being linked to an input/output port for transfer messages from the reading terminal.

The invention finally relates to a first computer program product designed to be stored in a memory of a terminal as described previously, said first program product comprising instructions at least for implementing the steps c), d) and e) of a data reading method according to the invention.

It also relates to a second computer program product designed to be stored in a memory of a protection removal tool as described previously, said second program product comprising instructions at least for implementing the steps g) and h) of a data reading method according to the invention.

Other features and advantages of the present invention will become apparent from the description below of two exemplary and nonlimiting embodiments, with reference to the appended drawings, in which:

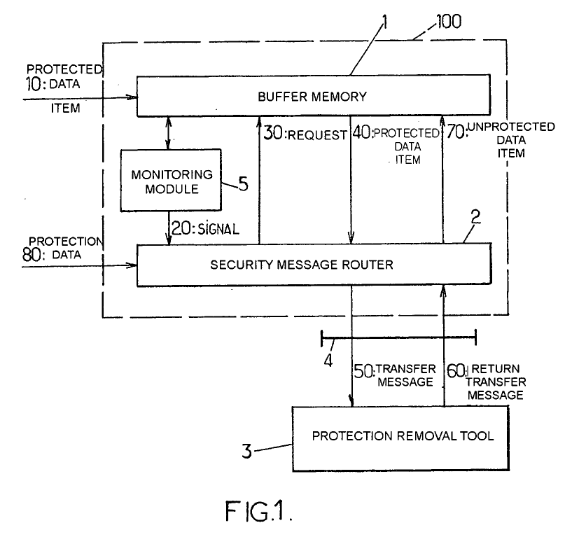

FIG. 1 is a simplified block diagram of a data reading device according to the invention; and

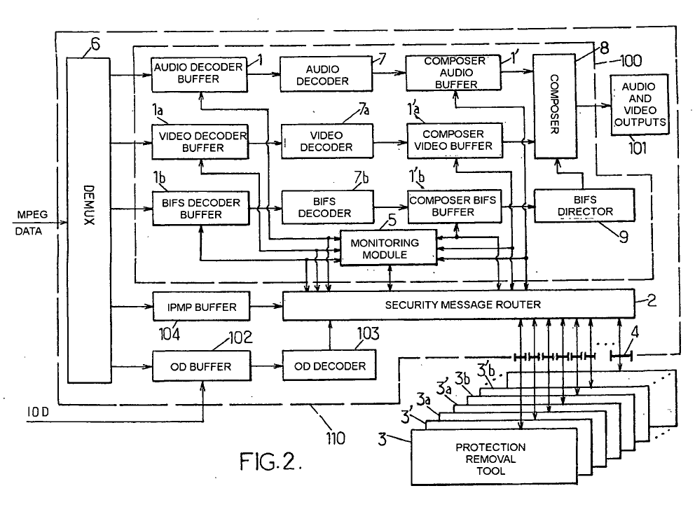

FIG. 2 is a block diagram of a multimedia reader according to the invention.

In these figures, identical references correspond to identical elements or elements having identical functions in relation to the invention.

According to FIG. 1, a reading device 100 comprises an input buffer memory 1 and a security message router 2. The memory 1 is arranged within the device 100 to store application-level data, after this data has been extracted from a stream transmitted by an external broadcasting server that is not represented. The router 2 is linked to the memory 1 in such a way that the router 2 can read and write data in the latter. The router 2 is further connected to a tool for removing a protection from the data 3 via an input/output port 4.

The protection removal tool can take a number of forms. This can, in particular, be a module or a card designed to be inserted in a dedicated recess of the device 100. It can also be a unit external to the device 100.

If necessary, the device 100 can be equipped with several input/output ports similar to the port 4, in order to be able to be connected simultaneously to several data protection removal tools. Such tools can correspond to different protections likely to be applied to the transmitted data. They can also correspond to one and the same protection, for example to obtain a greater capability for removing this protection for large data streams.

The data extracted from the stream transmitted by the broadcasting server is entered into the memory 1, in a manner known to those skilled in the art (step 10). A test is then carried out, within the device 100, to detect the presence of a protected data item in the memory 1. Such a test can be applied, for example, to a protection indicator present in each data item. When a protected data item is detected, a specific signal 20 is transmitted to the router 2, in order to activate a sequence for removing the protection from the data item. According to a particular embodiment of the invention, the detection of a protected data item in the memory 1 and the sending of the signal 20 are performed by a module 5 for monitoring the content of the memory 1, dedicated to this task.

In response to the signal 20, the router 2 orders the removal of the protection from the data item, and a storage in the memory 1 of the data item from which the protection has been removed (step 70). When several protected data items are detected as simultaneously present in the memory 1, the router 2 further coordinates the processes for removing the protection from each of these data items. In particular, it can order the respective processes for removing the protection from each of the data items according to a chronological order determined on the basis of time stamps read in the data items.

The ordering, by the security message router 2, of the removal of the protection from a data item is performed as follows. After having received the signal 20, the router 2 sends a request 30 to transfer the detected protected data item. In response to the request 30, the protected data item is transmitted to the router 2 (step 40). The router 2 then produces a first transfer frame, having a payload field in which the protected data item is entered. The first frame with the protected data item constitutes the message for transferring the protected data item to the protection removal tool 3.

According to a preferred embodiment of the invention, the first frame also comprises a data item length field, in which the router 2 enters a length of said protected data item, simultaneously with the entry of the protected data item in the payload field. In a known manner, such a length field makes it possible to check that the transfer of the message between the router 2 and the tool 3 has been correctly carried out, by comparing a measured length of the protected data item received by the tool 3 with the length read by the tool 3 in the length field of the first frame.

According to an improvement of the invention, the router 2 can further enter, in a dedicated field of the first frame, a time stamp of the protected data item. The time stamp thus remains associated with the data item on its transfer for removal of the protection.

Such an entry of the time stamps in the first frames offers the following advantages:
the encryption algorithms are often based on a synchronization between the data and encryption keys. The time stamps are then information that is convenient for performing such a synchronization. This is particularly useful in the case of encryption algorithms that work in counter mode, for which a particularly fine synchronization is necessary;
the entry of the time stamps in the first frames also makes it possible to check certain data usage rights based on the time stamps. A typical such situation is, for example, that of a limited listening time for an audio content;
the entry of time stamps also makes it possible to detect a time window in a sequence using a digital tattooing tool. The time stamps of the first data item containing the start tattoo and of the last data item containing the end tattoo make it possible to calculate the duration of the sequence. One application can be to calculate the cost of an advertisement according to its duration.

As an example, the first frame can have the following structure, constructed by extending the frames proposed in the MPEG-2 IPMPX and MPEG-4 IPMPX standards:
a first 8-bit field intended to receive an identifier of the frame indicating that it contains a protected data item,
a second 16-bit field intended to receive the length, expressed in bytes, of the protected data item,
a third 32-bit field intended to receive the time stamp attached to the protected data item, and
a fourth field, called payload, and intended to receive the data item.

The fourth field has a variable length that corresponds to the indication entered in the second field.

Upon receiving the transfer message (step 50), the tool 3 executes the removal of the protection from the data item. This removal, applied to the data item itself, is executed within the tool 3. The individual operations performed on the data item to remove the protection can be similar to those performed on a protection removal executed within the device 100, in a manner known from the prior art.

The unprotected data item is then entered by the tool 3 in a second frame, intended to transfer the data item in return to the router 2 (step 60). This return transfer is also executed via the input/output port 4. The second frame can have a structure similar to that of the first frame described above. In particular, the second frame can comprise:
a first 8-bit field intended to receive an identifier of the second frame indicating that it contains an unprotected data item,
a second 16-bit field intended to receive the length of the unprotected data item,
a third 32-bit field intended to receive a time stamp attached to the unprotected data item, and
a fourth field (payload) intended to receive the unprotected data item, of variable length corresponding to the indication entered in the second field.

Thus, said first and second frames, respectively used to transfer the protected data item to the tool 3 and to transfer in return the unprotected data item to the router 2, correspond to different message classes, distinguished by respective identifiers entered in the first fields of each frame.

The length of the unprotected data item is entered in the second field, or length field, of the second frame at the same time as the unprotected data item is itself entered in the payload field. As for the first frame, it makes it possible to check that the return transmission of the unprotected data item has been correctly performed.

The time stamp of the unprotected data item is entered in the third field of the second frame when the unprotected data item is itself entered in the payload field. Preferably, this time stamp is identical to that conveyed in the first frame for the same data item. The association of the time stamp with the data item is thus preserved throughout the protection removal process.

When the router 2 receives the unprotected data item transfer message, it extracts the unprotected data item from the second frame and stores it in the memory 1. The data item duly placed in the memory 1 can then be transmitted to a reading subsystem of the device 100.

When one and the same data item stored in the memory 1 has several combined protections, applied in succession to the data item, the router 2 transmits in succession the data item to protection removal tools connected to respective ports similar to the port 4. The transmission of the data item between the router 2 and each tool is performed in the way that has just been described. When the router 2 receives in return the data item from one of the protection removal tools, after this tool has removed the corresponding protection, the router 2 addresses the data item to another protection removal tool, determined according to an order of said protections known to the router 2. For this, configuration data relating to the different protections of the data and to the tools for removing these protections are transmitted to the router 2 in a manner that is described below in the case of an MPEG-4 reading terminal.

FIG. 2 illustrates the application of the invention to a terminal for reading MPEG-4 IPMPX data. In a known manner, such a terminal 110 comprises a demultiplexer 6 receiving as input the MPEG data transmitted by an external server or obtained by locally reading an MP4 file. The demultiplexer 6 is connected by its output to different channels of a reading device 100. Each channel of the device 100 is dedicated to reading data of a predetermined type, such as audio data, video data, scene-building data (called BIFS, standing for Binary Format for Scenes). Each of these channels comprises a respective decoding stage and a common composition stage. A buffer memory is positioned at the input of each stage in each channel, to allow the data to be temporarily stored between two stages.

Thus, the channel for processing audio data comprises a first buffer memory 1 positioned between an audio data output of the demultiplexer 6 and an audio decoder 7. This first memory is called decoder audio buffer. The channel for processing audio data further comprises a second buffer memory 1′ positioned between an output of the audio decoder 7 and an audio input of a composer 8. This second memory is called composer audio buffer.

Similarly, the channel for processing video data comprises, according to the video data processing order, a decoder video buffer 1a, a video decoder 7a and a composer video buffer 1′a connected to a video input of the composer 8.

The channel for processing BIFS data comprises a BIFS data decoder buffer 1b, a BIFS data decoder 7b, and a composer BIFS buffer 1′b linked by output to a BIFS input of the composer 8. A BIFS directing module 9 is connected between the output of the composer BIFS buffer 1′b and the BIFS input of the composer 8.

The composer 8 is linked to audio and video outputs 101 of the terminal 110.

The data of each type (audio, video, BIFS, or other) can be protected at the decoding level of the latter or in the composer 8.

In the case of a coding-level protection, the protection is removed by working on each protected data item stored in one of the decoder buffer memories corresponding to the type of the data item. The protected data items contained in the memories 1, 1a or 1b are access units, as defined in the MPEG-4 standard. The protected MPEG access units are transferred by the router 2 to appropriate protection removal tools from the corresponding decoder buffer memory. The protection removal tool to which a data item is transferred can depend on the type of the data item. Thus, with reference to FIG. 3, protected data items contained in the memories 1, 1a and 1b are respectively transferred by the router 2 to the tools 3, 3a and 3b to remove the protections from each of them. The router 2 then enters the unprotected data items returned respectively by each tool 3, 3a or 3b in the original memory 1, 1a or 1b corresponding to the type of the data item.

In the case of a composition-level protection, the protection is removed in the same way by working on the data stored in the composer buffer memories 1′, 1′a and 1′b. The data items stored in these memories are called composition units in the MPEG-4 standard. The protection removal tools 3′, 3′a and 3′b correspond to composer-level protections relating to the audio, video and BIFS channels respectively.

Advantageously, frames belonging to different classes can be used for data items of different types, for data items of different stages in the reading subsystem, namely for MPEG access units or MPEG composition units, or even for data items of one and the same type and of one and the same stage but having different protections. The processing of each data item within the router 2 is then determined simply according to the class of the frame or frames used for this data item. The classes of the frames can be distinguished from each other by a specific indicator entered in each frame. If appropriate, this indicator can be incorporated in the identifiers of the frames cited above.

Configuration data is necessary for the operation of the security message router 2. Such data comprises in particular a main list of protection removal tools connected to the terminal 110, an ancillary list of protection removal tools that have to be activated when one of the tools in the main list fails, and various configuration parameters of the router 2. Initial values for this data are contained in the MP4 files for reading in local mode or in a session initialization file (SDP, standing for Streaming Data Protocol, defined in the RFC2327 standard) when accessing a transmitted stream. The object that contains this data is called “Initial Object Descriptor”, or 10D. This IOD file is read when the reading terminal 110 is started up. Some of this initial data can then be updated on reading the broadcasted MPEG data. For this, the terminal 110 has an additional channel for receiving data contained in the transmitted MPEG stream, positioned between a dedicated output of the demultiplexer 6 and a dedicated input of the router 2. This channel comprises a buffer memory for the configuration data of the router 2, referenced 102 in FIG. 2 and called OD (Object Descriptor) buffer memory, and a dedicated decoder referenced 103. The buffer memory 102 is connected to receive as input the data from the IOD file, then the update data transmitted in the broadcasted MPEG stream.

The transmitted MPEG stream finally comprises data for configuring and parameterizing the protection removal tools themselves. This data, called IPMP data, is transmitted to protection removal tools 3, 3′, 3a, 3′a, etc., connected to the terminal 110. This IPMP data is isolated by the demultiplexer 6 from the other data contained in the broadcasted MPEG stream. It is stored in a dedicated buffer memory 104 and then transmitted by the security message router 2 to the appropriate protection removal tools.

1: A method for reading data items received in protected form, comprising, for at least one of the received protected data items, the following steps:
a—storing the protected data item in an input buffer memory unit;
b—sending a signal to a security message router, indicating that a protected data item is present in the input buffer memory unit;
c—producing a first data transfer frame;
d—reading the protected data item in the input buffer memory unit;
e—entering the protected data item in the first frame; and
f—transmitting the first frame containing the protected data item to a tool for removing the protection from the data item,
wherein steps c, d, e and f are controlled by the security message router in response to the signal indicating the presence of a protected data item in the input buffer memory unit.

2: The method as claimed in claim 1, wherein the data item is an MPEG access unit or an MPEG composition unit.

3: The method as claimed in claim 1, wherein the first frame comprises a data length field, and wherein, in the step e, a length of said protected data item is also entered into said length field.

4: The method as claimed in claim 1, wherein a time stamp of the protected data item is entered with said protected data item in the first frame.

5: The method as claimed in claim 1, further comprising the following steps, executed after the protection has been removed from said data item:
g—producing a second data transfer frame;
h—entering the unprotected data item in the second frame;
i—transmitting the second frame containing the unprotected data item to the security message router; and
j—storing the unprotected data item in the input buffer memory unit.

6: The method as claimed in claim 5, wherein the second frame comprises a data length field, and wherein, in the step h, a length of said unprotected data item is further entered into said length field of the second frame.

7: The method as claimed in claim 5, wherein a time stamp of the unprotected data item is entered with said unprotected data item in the second frame.

8: The method as claimed in claim 5, wherein said first and second transfer frames correspond to different message classes, distinguished by respective identifiers entered in each transfer frame.

9: The method as claimed in claim 1, wherein, for at least one of the protected data items received, the security message router successively selects a protection removal tool out of several tools based on an access control table, and wherein said router sends said data item to the selected tool in order for the protection corresponding to said selected tool to be removed from said data item, the method then being repeated for said data item with a subsequent protection removal tool indicated in said access control table.

10: A data reading terminal comprising:
an input buffer memory unit designed to store received data items;
at least one transfer message input/output port;
a security message router connected on the one hand to the input buffer memory unit and on the other hand to the transfer message input/output port;
means for detecting a protected data item in the input buffer memory unit; and
means for sending a signal to the security message router, arranged to be activated when a protected data item is detected in the input buffer memory unit, said security message router incorporating:
means for producing a first data transfer frame;
means for controlling a read of a protected data item in the input buffer memory unit;
means for entering a protected data item that has been read in a said first frame; and
means for transmitting a first frame containing a protected data item that has been read via the input/output port, said means of the security message router being arranged to be activated in response to a signal indicating detection of a protected data item in the input buffer memory unit.

11: The terminal as claimed in claim 10, adapted to read a data item composed of an MPEG access unit or an MPEG composition unit.

12: The terminal as claimed in claim 10, wherein the security message router further comprises means of entering a length of a protected data item in a length field of a first frame containing said protected data item.

13: The terminal as claimed in claim 10, wherein the security message router further comprises means of entering, with a protected data item in a first frame, a time stamp of said protected data item.

14: The terminal as claimed in claim 10, wherein the security message router further comprises:
means for reading an unprotected data item contained in a second frame received on the input/output port; and
means for controlling an entry, in the input buffer memory unit, of an unprotected data item that has been read in a said second frame.

15: The terminal as claimed in claim 10, comprising several data transfer message input/output ports, means for storing an access control table, and means for selecting one of said input/output ports from said access control table, said selection means being arranged to be activated upon a transmission of a said first frame containing a protected data item.

16: A tool for removing a protection applied to data items comprising:
an input/output port for frames containing data items;
means for reading a protected data item in a first frame received on the input/output port;
means for removing the protection from a data item that has been read;
means for producing a second data transfer frame;
means for entering in a said second frame a data item from which the protection has been removed; and
means for transmitting a second frame containing an unprotected data item via the input/output port.

17: The tool as claimed in claim 16, further comprising means for entering a length of an unprotected data item in a length field of a second frame containing said unprotected data item.

18: The tool as claimed in claim 16, further comprising means for entering, with an unprotected data item in a second frame, a time stamp of said unprotected data item.

19-21. (canceled)

22: A security message router to be connected on one hand to an entry buffer memory unit of a data reading terminal, and on the other hand to at least one transfer message input/output port of said reading terminal, said router comprising:
means for producing a first data transfer frame;
means for controlling a red of a protected data item in the input buffer memory unit;
means for entering a protected data item that has been read in a said first frame; and
means for transmitting a first frame containing a protected data item that has been read via the input/output port, said means of the security message router being arranged to be activated in response to a signal indicating detection of a protected data item in the input buffer memory unit.
